(19) United States
(12) Patent Application Publication
(10) Pub. No.: US 2025/0224293 A1
(43) Pub. Date: Jul. 10, 2025

(54) METHOD FOR COMPENSATION FOR AN INFLUENCE OF AN ALTERNATIVE MEDIUM AND MICROSENSOR DEVICE

(71) Applicant: Robert Bosch GmbH, Stuttgart (DE)

(72) Inventors: Joachim Kreutzer, Stuttgart (DE); Arne Dannenberg, Metzingen (DE)

(21) Appl. No.: 19/007,884

(22) Filed: Jan. 2, 2025

(30) Foreign Application Priority Data
Jan. 9, 2024 (DE) 10 2024 200 181.3

(51) Int. Cl. G01L 9/12; G01L 19/00; H04R 19/04

(52) U.S. Cl. CPC G01L 9/12; G01L 19/00; H04R 19/04; H04R 2201/003

(57) ABSTRACT

A method for compensation for an influence of an alternative medium deviating from an ambient medium on a sensor signal of a microsensor device. The method includes providing the microsensor device having at least one sensor element having at least one sensor component that can be deflected depending on a measured variable of the ambient medium and a measuring device having an electrical measurement parameter that varies depending on the deflection of the sensor component, along with an evaluation unit that is electrically connected to the measuring device, detecting the measurement parameter, providing a sensor signal depending on the measurement parameter using the evaluation unit, detecting at least a presence of the alternative medium at the sensor component, wherein the foreign signal component in the sensor signal caused by the alternative medium is compensated for depending on the detection of the alternative medium.

### CROSS REFERENCE

The present application claims the benefit under 35 U.S.C. § 119 of Germany Patent Application No. DE 10 2024 200 181.3 filed on Jan. 9, 2024, which is expressly incorporated herein by reference in its entirety.

### FIELD

The present invention relates to a method for compensation. The present invention further relates to a microsensor device.

### BACKGROUND INFORMATION

U.S. Patent Application Publication No. US 2019/100428 A1 describes an environmental sensor that has a microelectromechanical pressure sensor and an electrical integrated circuit that is electrically connected to the pressure sensor. Furthermore, capacitive elements are arranged that can detect the presence of water and oil in the measuring volume.

### SUMMARY

According to the present invention, a method for compensation for an influence of an alternative medium deviating from an ambient medium on a sensor signal of a microsensor device.

According to an example embodiment of the present invention, the method includes providing the microsensor device having at least one sensor element having at least one sensor component that can be deflected depending on a measured variable of the ambient medium and a measuring device having an electrical measurement parameter that varies depending on the deflection of the sensor component, along with an evaluation unit that is electrically connected to the measuring device, detecting the measurement parameter, providing a sensor signal depending on the measurement parameter by means of the evaluation unit, detecting at least a presence of the alternative medium at the sensor component, wherein the foreign signal component in the sensor signal caused by the alternative medium is compensated for depending on the detection of the alternative medium, by at least one electrical and/or electromagnetic operating parameter of the measuring device being actively changed and/or the sensor signal being directly cleaned of the foreign signal component and output as a cleaned sensor signal. As a result, measurement errors of the microsensor device can be reduced. The microsensor device can measure the measured variable more accurately and reliably.

According to an example embodiment of the present invention, the microsensor device can be a microelectromechanical microsensor device. The microsensor device can be a pressure sensor, in particular a capacitive pressure sensor and/or a microphone, in particular a capacitive microphone. The microsensor device can be installed in a vehicle, watercraft, aircraft, robot, a mobile, stationary or movable device, an industrial device or a consumer end product. The pressure sensor can measure an absolute pressure of an ambient medium or a differential pressure between a pressure of an ambient medium and a reference pressure or a pressure of another medium.

The measured variable can be a physical variable of the ambient medium of the microsensor device. The ambient medium can be adjacent to the sensor component. The ambient medium can be air. The measured variable can be a pressure, preferably an ambient pressure, in particular a barometric air pressure or a water pressure. The measured variable can be a sound vibration.

The alternative medium can be present directly on the sensor element. The alternative medium can at least partially replace the ambient medium at the sensor element. The alternative medium can be an alternative ambient medium. The alternative medium can be desirable or undesirable at the sensor element as an alternative to the ambient medium. The alternative medium differs from the ambient medium, in particular in terms of consistency, composition and/or density. The alternative medium and the ambient medium can be the same or different substances, but with different physical properties, for example the aggregate state. The alternative medium can be liquid or solid and the ambient medium can be gaseous. The ambient medium can also be liquid and the alternative medium gaseous. The alternative medium can be water, dirt and/or oil. The alternative medium can differ from the ambient medium due to the dielectric constant.

According to an example embodiment of the present invention, the sensor component can be a membrane that can be deflected depending on the measured variable. The membrane can be made of silicon, in particular monocrystalline or polycrystalline silicon. The sensor component can measure the ambient variable capacitively, piezoelectrically and/or piezoresistively. The sensor element can be fastened to an electronics unit and/or a carrier element, in particular a substrate. The sensor element can be connected to the electronics unit and/or the carrier element in a form-fit, material-fit and/or force-fit manner. The sensor element can be adhesively bonded to the electronics unit and/or the carrier element. The electronics unit can comprise or form the evaluation unit. The electronics unit can have an integrated circuit.

The electronics unit and/or evaluation unit can have an ASIC. The evaluation unit can be arranged inside or outside the microsensor device.

The measuring device and the electronics unit can be electrically connected to each other, in particular via bonding wires, silicon through-connections, solder joints, and/or eutectic connections.

The measuring device can comprise at least one measuring unit that has or assumes the measuring parameter. The measuring device can have a plurality of measuring units, each of which has a measuring parameter that depends on the deflection.

According to an example embodiment of the present invention, a protective compound can be arranged facing the sensor environment at least above the sensor component and/or the electronics unit. The protective compound can protect the embedded components from the sensor environment, in particular by insulating them electrically. The protective compound can enclose the bonding wires. The protective compound can be a gel. A layer thickness of the protective compound on the bonding wires can be less than or equal to 100 μm, in particular less than or equal to 25 μm, preferably less than or equal to 5 μm.

The foreign signal component can be an interference component as an unwanted component in the sensor signal. The foreign signal component can be a component in the sensor signal that is specifically used to detect the alternative medium, for example in an underwater application of the microsensor device. The foreign signal component can be caused by a capacitive influence of the alternative medium on the measuring capacitance. A dielectric constant of the alternative medium can deviate from a dielectric constant of the ambient medium. The foreign signal component can at least act as an offset in the sensor signal.

An operating parameter is a parameter of the measuring device itself or a parameter with which the measuring device is operated or a boundary condition applied to the measuring device. The operating parameter can be independent of the measured variable.

An electrical measurement parameter is understood to mean an electrically detectable and quantifiable parameter, such as an electrical capacitance value.

The electrical operating parameter and/or measurement parameter can be an electrical voltage, an electrical current, an electrical capacitance, an electrical resistance and/or an electrical inductance. The electromagnetic operating parameter can be an electrical permittivity, a magnetic permeability, a field strength, a frequency, an impedance and/or a polarization.

According to an example embodiment of the present invention, the microsensor device can have at least one cavity spanned by the sensor component at least in portions. The measuring device can be arranged inside the cavity. The cavity can be sealed against the sensor environment. The cavity can have a fluid pressure that differs from the sensor environment, preferably one that is lower than the sensor environment. The cavity can have a vacuum.

In a preferred example embodiment of the present invention, it is advantageous if the measuring device comprises an electrical measuring capacitor, the electrical measuring parameter is a capacitance value of the measuring capacitor that depends on the deflection and the operating parameter is a basic capacitance value of the measuring capacitor. The basic capacitance value can be the capacitance value of the measured capacitor that is independent of the measured variable.

The measuring unit can comprise the measuring capacitor or be formed by the measuring capacitor. The measuring capacitor can have at least one electrode movably connected to the sensor component and a counter electrode spaced apart from the electrode. The electrode and the counter electrode can be made of a semiconductor layer, in particular a silicon layer or metal layer. The electrode and the counter electrode can be arranged in the cavity. An electrical capacitance between the bonding wires can influence the measuring capacitance.

In a preferred example embodiment of the present invention, it is advantageous if the measuring device has a reference unit that has an electrical reference parameter that is independent of the movement of the sensor component. The term “reference parameter” does not mean that it is necessarily constant or predefined, but that this parameter can serve as a reference.

An electrical reference parameter is understood to mean an electrically detectable and quantifiable parameter, such as an electrical capacitance value. The reference parameter can deviate from the operating parameter of the reference unit or correspond to the operating parameter of the reference unit.

The measuring device and the reference unit can be electrically interconnected in a half-bridge or full-bridge circuit.

The reference unit can have an electrical reference capacitor. The reference parameter can be a reference capacitance value of the reference capacitor. The reference capacitor can have a reference electrode and reference counter electrode spaced apart from the deflectable sensor component in the direction of the sensor environment. The sensor component can be moved relative to the reference electrode and the reference counter electrode. The reference electrode and the reference counter electrode can be fixed relative to the carrier element. The reference electrode and the reference counter electrode can be made of a semiconductor layer, in particular a silicon layer or metal layer. The reference electrode and the reference counter electrode can be arranged in the cavity.

The reference capacitor can form an interdigital structure for increasing the electrical capacitance.

In addition to the measuring unit which has the measuring parameter as an electrical measuring parameter dependent on the deflection of the sensor component as a first measuring unit, the measuring device can have a second measuring unit which has a further electrical measuring parameter that varies depending on the deflection of the sensor component.

In addition to the reference unit as a first reference unit, the microsensor device can have a second reference unit which has a further electrical reference parameter that is independent of the movement of the sensor component.

The first measuring unit, the second measuring unit, the first reference unit and the second reference unit can be interconnected in a full-bridge circuit.

Different media, for example the ambient medium air compared to the alternative medium water, can have different dielectric constants, which in particular influence the electrical capacitances, for example of the measuring unit, the reference unit and/or the electrical connections, in particular between the bonding wires and thus the measuring capacitor and/or the reference capacitor directly or indirectly. The smaller the distance between the bonding wires and the particular medium, the stronger this influence is, and this distance can in turn depend on the layer thickness of the protective compound.

In a specific example embodiment of the present invention, it is advantageous if the sensor signal is provided by the evaluation unit depending on the measurement parameter and the reference parameter. The sensor signal can be formed by superimposing or differentiating the measurement parameter and the reference parameter.

In an advantageous example embodiment of the present invention, the foreign signal component in the sensor signal caused by the alternative medium is compensated for depending on the detection of the alternative medium, by an electrical and/or electromagnetic operating parameter of the reference unit being changed. Alternatively or additionally, an electrical and/or electromagnetic operating parameter of the measuring unit can be changed to compensate for the foreign signal component in the sensor signal.

In a specific example embodiment of the present invention, it is advantageous if the evaluation unit detects at least a presence of the alternative medium at the sensor component. The evaluation unit can detect the presence of the alternative medium on the sensor component by detecting a change in the measurement parameter and/or the reference parameter.

In addition to the presence of the alternative medium, the evaluation unit can also ascertain a physical property, in particular a temperature-dependent property, an electrical property, in particular an electrical conductivity, an optical property, an electromagnetic property, a magnetic property, a volume, a density and/or a mass of the alternative medium present on the sensor component.

The microsensor device can detect the alternative medium by applying algorithms and/or artificial intelligence.

The microsensor device can have an electrically operated coil that introduces a variable magnetic field into the alternative medium and capacitively detects the alternative medium, preferably an electrical conductivity of the alternative medium, in particular via the reference capacitor, depending on the electrical voltage generated by charge carrier displacements in the alternative medium. The coil can be a planar coil or a wound coil with a permanent magnet core. The coil can be attached to the electronics unit or the sensor component.

The microsensor device can have at least one heating element that makes it possible to heat a surface covered with the alternative medium. As a result, the alternative medium can be detected.

In a preferred example embodiment of the present invention, it is advantageous if the provided sensor signal is digitized and the output cleaned sensor signal is digitized. The sensor signal can be cleaned of the foreign signal component in the digital sensor signal, in particular downstream of an analog-to-digital converter. The sensor signal can be cleaned of the foreign signal component by a signal offset of the sensor signal being changed. The signal offset can be increased by an additional offset or reduced by an additional offset. The additional offset can assume a predefined value or a plurality of predefined values. The value of the additional offset can depend on a detection of the alternative medium, in particular a detected physical property of the alternative medium.

In an advantageous example embodiment of the present invention, the active change of the operating parameter includes an active change of the electrical circuit of the measuring device and/or an active change of a parameter of the measuring device. The modification of the electrical circuit can may involve adding, removing or switching at least one electrical component of the electrical circuit. The electrical component can be an electrical capacitor.

The parameter that can be actively changed can be a magnetic, electrical or electromagnetic parameter. The parameter can be set variably or in steps.

The measuring device can have an electrical component and a parameter of the component can be set for actively changing the parameter.

In a preferred example embodiment of the present invention, it is advantageous if the foreign signal component in the sensor signal caused by the alternative medium is compensated for in a control loop. As a result, the foreign signal component can be compensated for more accurately and quickly and the sensor signal can be generated reliably. The measuring device can be operated electrically within a predefined operating range.

The control loop can have the reference parameter as the controlled variable. The control loop can change the operating parameter, in particular the electrical circuit, of the reference unit depending on the reference parameter. The control loop can change the electrical circuit in such a way that the reference parameter remains as constant as possible. The correction variable calculated by the control loop can specify a presence and/or a physical property of the alternative medium.

According to an example embodiment of the present invention, a microsensor device is also provided.

Further advantages and advantageous embodiments of the present invention can be found in the description of the figures and in the figures.

### BRIEF DESCRIPTION OF THE DRAWINGS

The present invention is described in detail below with reference to the figures.

FIG. 1 shows a cross-section of a microsensor device in a specific example embodiment of the present invention.

FIG. 2 shows a circuit diagram of a measuring device of the microsensor device in a specific example embodiment of the present invention.

FIG. 3 shows a method for compensation in a specific example embodiment of the present invention.

FIG. 4 shows a method for compensation in a further specific example embodiment of the present invention.

FIG. 5 shows a method for compensation in a further specific example embodiment of the present invention.

FIG. 6 shows a method for compensation in a further specific example embodiment of the present invention.

### DETAILED DESCRIPTION OF EXAMPLE EMBODIMENTS

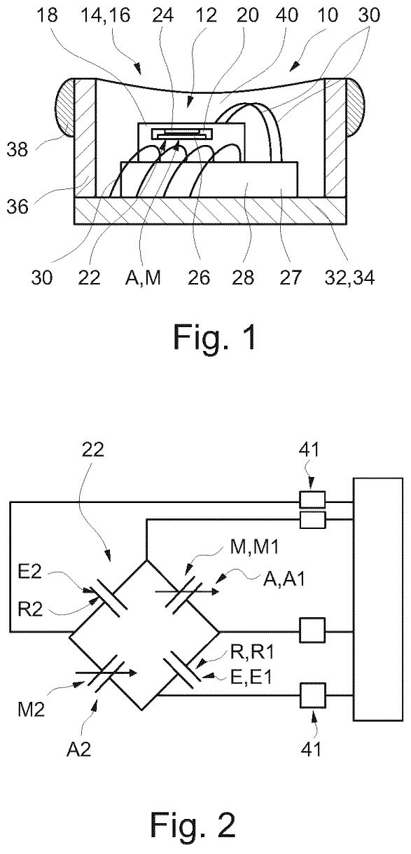

FIG. 1 shows a cross-section of a microsensor device in a specific example embodiment of the present invention. The microsensor device 10 comprises a sensor element 12 having a sensor component 18, here in particular a membrane, which can be moved in a sensor environment 16 depending on a measured variable of an ambient medium 14. The sensor component 18 spans a cavity 20. In particular, a measuring device 22 is arranged in the cavity 20, which measuring device has an electrical measuring parameter that varies depending on the movement of the sensor component 18. The measuring device 22 comprises a measuring unit A with an electrical measuring capacitor M, having an electrode 24 connected to the sensor component 18 and a fixed counter electrode 26. An electronics unit 27 with an evaluation unit 28 is electrically connected to the sensor element 12 via bonding wires 30. The sensor element 12 is arranged on the electronics unit 27 and the electronics unit 27 is fastened to a carrier element 32, in particular a substrate 34, and is electrically connected to the carrier element 32 via further bonding wires 30.

The sensor element 12 and the electronics unit 27 are accommodated in a housing 36 on the carrier element 32. A sealing element 38, in particular a sealing ring, is arranged on the housing 36. The sensor element 12, the electronics unit 27 and the bonding wires 30 are covered with a protective compound 40, in this case a protective gel, for protecting them against environmental influences of the sensor environment 16.

FIG. 2 shows a circuit diagram of a measuring device of the microsensor device in a specific embodiment of the present invention. The measuring device 22 comprises the measuring unit A having the electrical measuring capacitor M. The electrical measuring parameter is a capacitance value of the measuring capacitor M that depends on the deflection. Furthermore, in addition to the measuring unit A as a first measuring unit A1 and the measuring capacitor M as a first measuring capacitor M1 with the measuring parameter as a first measuring parameter, the measuring device 22 comprises a second measuring unit A2 with a second measuring capacitor M2 having an electrical second measuring parameter that varies depending on the movement of the sensor component. Furthermore, a reference unit E with a reference capacitor R is provided, which has an electrical reference parameter that is independent of the movement of the sensor component. In addition to the reference unit E as a first reference unit E1 with the reference capacitor R as a first reference capacitor R1 and the reference parameter as a first reference parameter, the measuring device 22 has a second reference unit E2 with a second reference capacitor R2, which provides an electrical second reference parameter that is independent of the movement of the sensor component.

The first measuring capacitor M1, the second measuring capacitor M2, the first reference capacitor R1 and the second reference capacitor R2 are connected in an electrical circuit, here preferably in a full-bridge circuit, and are each electrically connected to the evaluation unit via electrical interfaces 41, in particular bonding wires.

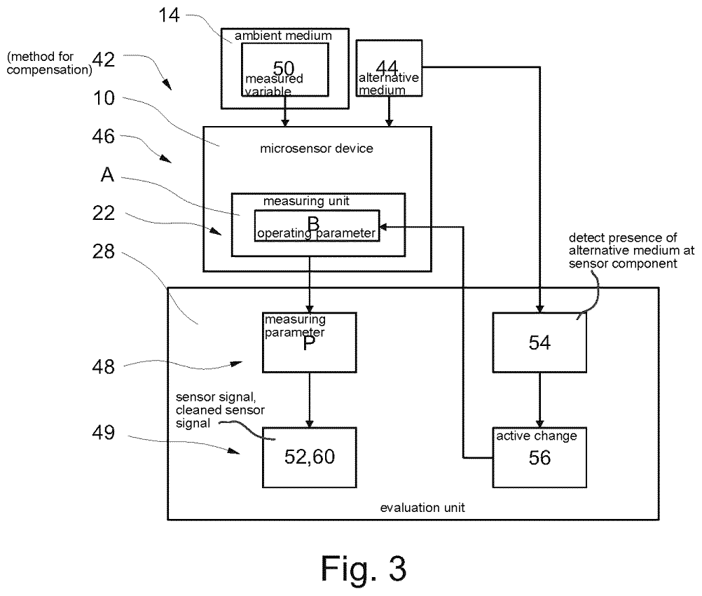

FIG. 3 shows a method for compensation in a specific embodiment of the present invention. The method for compensation 42 is carried out to compensate for an influence of an alternative medium 44 deviating from an ambient medium 14 on a sensor signal 52 of the microsensor device 10 shown, for example, in FIG. 1, and comprises providing 46 the microsensor device 10, detecting 48 the measuring parameter P of the measuring unit A of the measuring device 22, which parameter is dependent on the deflection of the sensor component and thus on the measured variable 50, by means of the evaluation unit 28, providing 49 a sensor signal 52 depending on the measuring parameter P by means of the evaluation unit 28, and detecting 54 at least a presence of the alternative medium 44 at the sensor component by means of the evaluation unit 28. The foreign signal component in the sensor signal 52 caused by the alternative medium 44 is compensated for by the evaluation unit 28 depending on the detection 54, by an active change 56 of at least one electrical and/or electromagnetic operating parameter B of the measuring device 22 being performed, as a result of which the foreign signal 52 is present as a cleaned sensor signal 60.

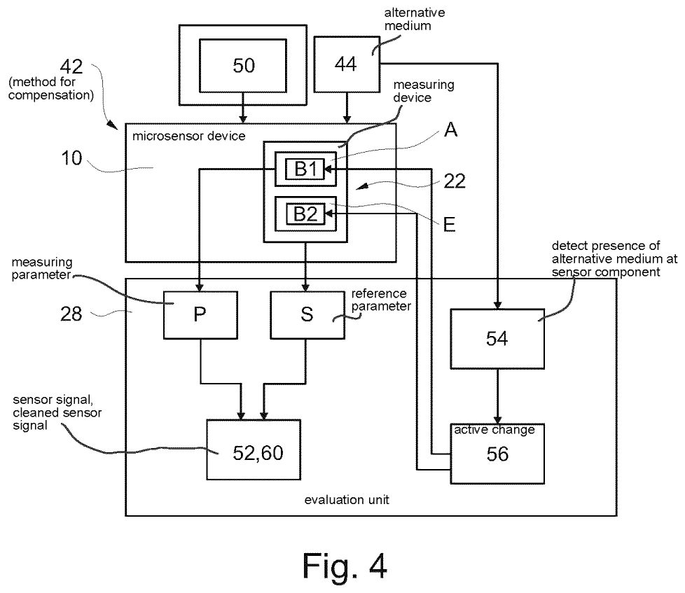

FIG. 4 shows a method for compensation in a further specific embodiment of the present invention. The method for compensation 42 is similar to that shown in FIG. 3, the description of which is hereby incorporated accordingly, except for the following differences. The microsensor device 10 comprises the measuring device 22 with the measuring unit A, which has the measuring parameter P, and a reference unit E, which has an electrical reference parameter S that is independent of the movement of the sensor component. The sensor signal 52 is provided by the evaluation unit 28 depending on the measurement parameter P and the reference parameter S. The foreign signal component in the sensor signal 52 caused by the alternative medium 44 is compensated for depending on the detection 54, by an electrical and/or electromagnetic operating parameter B1 of the measuring unit A and/or an electrical and/or electromagnetic operating parameter B2 of the reference unit E being changed, as a result of which the sensor signal 52 is present as a cleaned sensor signal 60.

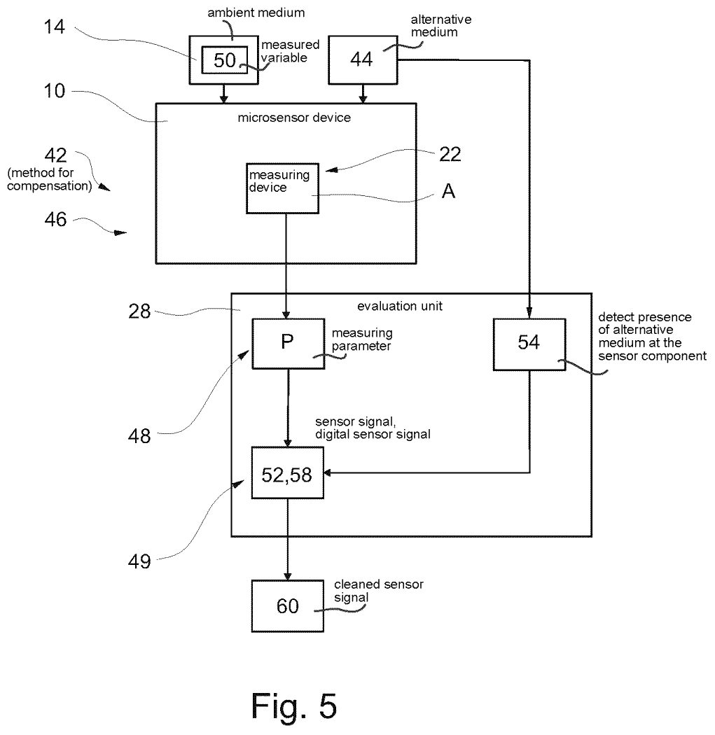

FIG. 5 shows a method for compensation in a further specific embodiment of the present invention. The method for compensation 42 is carried out to compensate for an influence of an alternative medium 44 deviating from an ambient medium 14 on a sensor signal 52 of the microsensor device 10 shown, for example, in FIG. 1, and comprises providing 46 the microsensor device 10, detecting 48 the measurement parameter P of a measuring unit A of the measuring device 22, which parameter is dependent on the deflection of the sensor component and thus on the measured variable 50, by means of the evaluation unit 28, and providing 49 the sensor signal 52 depending on the measurement parameter P by means of the evaluation unit 28. The sensor signal 52 provided is preferably digitized, i.e. a digital sensor signal 58.

Furthermore, detecting 54 at least a presence of the alternative medium 44 at the sensor component is carried out by the evaluation unit 28. The foreign signal component in the sensor signal 52 caused by the alternative medium 44 is compensated for by the evaluation unit 28 depending on the detection 54, by the sensor signal 52 being directly cleaned of the foreign signal component and output as a digitized cleaned sensor signal 60.

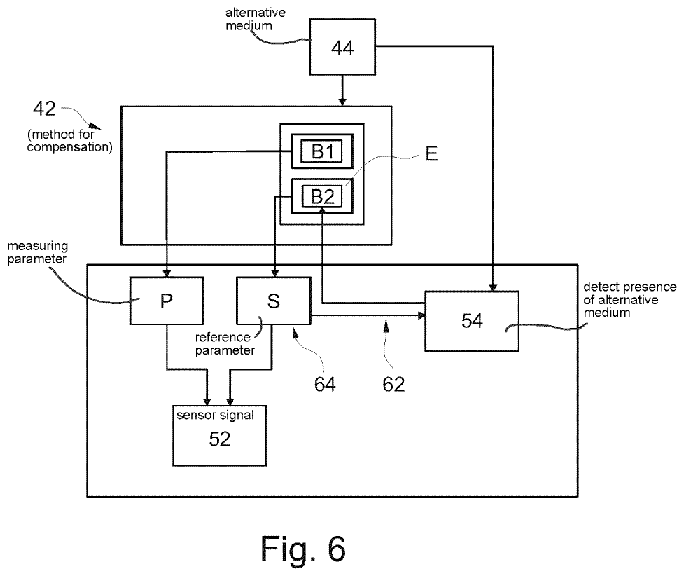

FIG. 6 shows a method for compensation in a further specific embodiment of the present invention. The method for compensation 42 for an influence is similar to that shown in FIG. 4, the description of which is hereby incorporated accordingly, except for the following differences. The foreign signal component in the sensor signal 52 caused by the alternative medium 44 is compensated for by a control loop 62 by, depending on the detection 54 of the alternative medium 44, control being performed by the control loop 52, which has the reference parameter S as the controlled variable 64 and which changes the operating parameter B2 of the reference unit E depending on the reference parameter S.

What is claimed is:

1. A method for compensation for an influence of an alternative medium deviating from an ambient medium on a sensor signal of a microsensor device, the method comprising:
providing the microsensor device including at least one sensor element having at least one sensor component that can be deflected depending on a measured variable of the ambient medium and a measuring device having an electrical measurement parameter that varies depending on the deflection of the sensor component, and an evaluation unit that is electrically connected to the measuring device;
detecting the measurement parameter;
providing a sensor signal depending on the measurement parameter using the evaluation unit; and
detecting at least a presence of the alternative medium at the sensor component;
wherein a foreign signal component in the sensor signal caused by the alternative medium is compensated for depending on the detection of the alternative medium, by at least one electrical and/or electromagnetic operating parameter of the measuring device being actively changed and/or the sensor signal being directly cleaned of the foreign signal component and output as a cleaned sensor signal.

2. The method for compensation according to claim 1, wherein the measuring device includes an electrical measuring capacitor, the electrical measuring parameter is a capacitance value of the measuring capacitor that depends on a deflection, and the operating parameter is a basic capacitance value of the measuring capacitor.

3. The method for compensation according to claim 1, wherein the measuring device has a reference unit that has an electrical reference parameter that is independent of movement of the sensor component.

4. The method for compensation according to claim 3, wherein the sensor signal is provided by the evaluation unit depending on the measurement parameter and the reference parameter.

5. The method for compensation according to claim 3, wherein the foreign signal component in the sensor signal caused by the alternative medium is compensated for depending on the detection of the alternative medium, by an electrical and/or electromagnetic operating parameter of the reference unit being changed.

6. The method for compensation according to claim 1, wherein the evaluation unit detects at least the presence of the alternative medium at the sensor component.

7. The method for compensation according to claim 1, wherein the provided sensor signal is digitized and the output cleaned sensor signal is digitized.

8. The method for compensation according to claim 1, wherein the active change of the operating parameter includes an active change of the electrical circuit of the measuring device and/or an active change of a parameter of the measuring device.

9. The method for compensation according to claim 1, wherein the foreign signal component in the sensor signal caused by the alternative medium is compensated for in a control loop.

10. A microsensor device, comprising:
at least one sensor element having at least one sensor component that can be deflected depending on a measured variable of an ambient medium and a measuring device having an electrical measurement parameter that varies depending on the deflection of the sensor component; and
an evaluation unit electrically connected to the measuring device configured to provide a sensor signal that depends on the measurement parameter;
wherein the microsensor device is configured to compensate for a foreign signal component in the sensor signal caused by an alternative medium by:
detecting at least a presence of the alternative medium at the sensor component,
wherein the foreign signal component in the sensor signal caused by the alternative medium is compensated for depending on the detection of the alternative medium, by at least one electrical and/or electromagnetic operating parameter of the measuring device being actively changed and/or the sensor signal being directly cleaned of the foreign signal component and output as a cleaned sensor signal.
